(19) United States
(12) Patent Application Publication
(10) Pub. No.: US 2006/0100766 A1
(43) Pub. Date: May 11, 2006

(54) Method for increasing the stability of a motor vehicle

(75) Inventors: Ralf Schwarz, Heidelberg (DE); Stefan Fritz, Erzhausen (DE); Rex Schilasky, Frankfurt (DE); Urs Bauer, Frankfurt (DE)

Correspondence Address: Gerlinde M Nattler;Continental Teves, One Continental Drive, Auburn Hills, MI, 18326, US

(73) Assignee: Continental Teves AG & Co. oHG

(21) Appl. No.: 10/518,857

(22) PCT Filed: Apr. 4, 2003
(86) PCT No.: PCT/EP03/07188

§ 371 Date: Oct. 6, 2005

(30) Foreign Application Priority Data
Jul. 5, 2002 (DE) 102 30 259.6
May 12, 2003 (DE) 103 21 385.6

(51) Int. Cl. G06G 7/76; G06F 7/00

(52) U.S. Cl. 701/71; 303/138; 701/70; 701/78

(57) ABSTRACT

In a method for increasing the driving stability of a vehicle during braking, compensation steering angles for a regulated and/or controlled steering system are calculated from several input parameters, so that the driving stability of the vehicle is increased by steering interventions. During the steering interventions at least two interference compensation portions for the compensation steering angles are taken into consideration in order to obtain a more comfortable control, from which an interference compensation portion is calculated on the basis of the vehicle course.

### BACKGROUND OF THE INVENTION

The invention relates to a method for increasing the driving stability of a motor vehicle during braking, in which compensation steering angles for a controllable steering system are calculated from several input parameters, so that the driving stability of the motor vehicle is increased by steering interventions and an ABS control method implementing controlled steering to compensate for a yaw behavior resulting from different brake effects on the two sides of a vehicle.

In particular, the invention relates to a method for stabilizing a motor vehicle and reducing the stopping distance during braking on inhomogeneous roads with different friction coefficients.

During braking on inhomogeneous roads (i.e. roads with different friction coefficients on the left and the right vehicle side) asymmetrical brake forces occur due to the different friction coefficients (right-left). These asymmetrical brake forces lead to a yaw torque around the vertical axis of the vehicle which cause the vehicle to carry out a yaw movement towards the road side with the higher friction coefficient. FIG. 1 represents a vehicle 10 on such an inhomogeneous road.

Vehicles which are not provided with the electronic brake system ABS get instable in such a driving condition since the cornering force of the tires gets lost when the tires block. The yaw torque resulting from the asymmetrical brake forces causes the vehicle to turn quickly around its vertical axis towards the side with the high friction coefficient (swerve).

In vehicles provided with the electronic brake system ABS swerving is avoided when braking in such critical situations since the cornering force of the wheels is maintained by avoiding blocking wheels. However, hereby the yaw torque around the vertical vehicle axis resulting from the asymmetrical brake forces is not compensated, but the driver has to compensate by countersteering. In such critical driving conditions (sudden occurrence of the yaw torque) the ABS control strategy is adapted, as described more in detail in FIGS. 2a and 2b, in order not to overstrain the driver. In this case the pressure build-up on the front axle is controlled during braking in such a way that the pressure difference on the front axle between the wheel on the high-friction side and the one on the low-friction side is built up only slowly. This leads to the fact that the yaw torque around the vertical vehicle axis is built up only slowly so that the driver has enough time for countersteering (yaw torque limitation on the front axle). At the same time the rear axle is underbraked in such a way that only the brake pressure of the wheel on the low-friction side is admitted on both wheels (SelectLow). Thus there is always sufficient cornering potential on the rear axle and the vehicle can be stabilized easily by the driver's steering interventions (countersteering). By these two ABS measures, yaw torque limitation on the front axle and SelectLow on the rear axle the principle pressure developments of which are described in the FIGS. 2a and 2b, very much braking power is given away since the friction coefficient potential of the high-friction side is not ideally utilized. This leads to a considerably longer stopping distance which, however, has to be considered as an advantage compared with a vehicle not provided with ABS which is getting instable.

This delay in building up the yaw torque which leads to a longer stopping distance, can be omitted or reduced when the compensation is carried out by means of an automatic steering intervention independent of the driver. In this regard DE 40 38 079 A1 describes an at least partial compensation of the yaw torque resulting from an ABS control in a μ-split driving condition by that a compensation steering angle depending on the difference of the separately adjusted brake pressures is set and/or is superimposed on the steering angle defined by the driver. The autonomous compensation steering angle (automatic countersteering) improves the maneuverability of the vehicle during braking on inhomogeneous roads. For that purpose an active steering system is necessary, i.e. a steering system with which an additional steering angle on the wheels can be generated in an active manner and irrespective of the driver's input. This can be achieved, for example, by means of a superimposed steering or a steer-by-wire steering system.

It is the object of the present invention to provide a method and a control which improves the maneuverability of the vehicle when braking on inhomogeneous roads, thus making the vehicle more comfortable.

### SUMMARY OF THE INVENTION

According to the present invention, this object is achieved by that in case of braking interventions an interference compensating portion is considered for the compensation steering angles which is determined on the basis of the vehicle course (or the driving condition).

This interference compensating portion is based on the yaw behavior of the vehicle and is part of a compensation steering angle demand comprising at least two interference compensating portions. Here, by means of the measuring data which are acquired by sensors and logically operated and analyzed in a model of the driving dynamics control in which the data of a motor vehicle may be included, a second interference compensating steering angle portion is generated for an active steering system (e.g. a superimposed steering or steer-by-wire steering) by comparing a nominal yaw signal with an actual yaw signal, the actuator of the active steering system being adjusted according to a compensation steering angle demand thus superimposing the steering angle indicated by the driver. Such active steering systems can be used on the front axle as well as on the rear axle or on all wheels of the vehicle.

The method, in an advantageous manner, includes the determination of a first interference compensating portion for the compensation steering angle demand Δδ taking into consideration the brake force differences on the braked wheels, a second interference compensating portion being determined on the basis of the vehicle course (i.e. driving condition) and the steering angle being modified on the basis of the interference compensating portions. In this connection, the first and the second interference compensating portions are preferably added up in an adding-up unit and made available to the regulation or control for correcting the steering angle input by the driver.

In order to precisely determine the second compensation portion, said second compensation portion should be determined in a device being provided with a reference vehicle model circuit in which the input parameters necessary for determining the vehicle course, i.e. vehicle speed, steering angle and, if necessary, the friction coefficient, are introduced which due to the vehicle model in the reference vehicle model circuit which simulates the characteristics of the vehicle, determines a nominal value for a controlled quantity and in which this nominal value is compared with a measured value for this controlled quantity in a comparing device, the second compensating portion of the steering angle Δδ_{R} being calculated from the comparative value (controlled quantity) in a driving condition control device. It is an advantage in this case that the yaw angle speed and/or the lateral acceleration and/or the floating angle and/or their derivations are determined as a nominal value for the controlled quantity.

The determined total compensation steering angle considers the movement of the vehicle in the space (vehicle condition), the compensating portions being determined from two parameters in such a way that the first compensating portion Δδ_{Z} is determined taking into consideration an interference yaw torque M_{z} on the basis of different brake forces and the second portion Δδ_{R} is determined taking into consideration the yaw behavior of the vehicle.

The steering angle correction method is advantageously structured in such a manner that the first compensating portion is intended to be a control portion and the second compensating portion is intended to be a control portion.

In this connection the interference yaw torque M_{z} is determined by means of a logic operation of the steering lock angle of the steered wheels, the brake pressures and the rotation behavior of the wheels. On the basis of the adjusted brake pressures, the brake forces are advantageously determined according to the relation
\hat{F}_{x,i}=f{r,B,pᵢ,J_{Whl},\dot{ω}ᵢ}
with
\hat{F}_{x,i}=brake force on one wheel i
r=dynamic wheel radius
B=brake parameter
pᵢ=wheel brake pressure
J_{Whl}=inertial torque of the wheel
\dot{ω}ᵢ=rotation acceleration of one wheel i
   or
   \hat{F}_{x,i}=f{r,B,pᵢ}.

The interference yaw torque is determined depending on the brake forces according to the relation
\hat{M}_{z}=f{\hat{F}_{FL},s_{FL},\hat{F}_{FR},s_{FR},l_{F},\hat{F}_{RL},s_{RL},\hat{F}_{RR}, s_{RR},δ}
with
\hat{F}_{FL}=brake force at the front on the left
s_{FL}=half the tread of the left front wheel
\hat{F}_{FR}=brake force at the front on the right
s_{FR}=half the tread of the right front wheel
l_{F}=distance of the front axle from the center of gravity
\hat{F}_{RL}=brake force at the rear on the left
s_{RL}=half the tread of the left rear wheel
\hat{F}_{RR}=brake force at the rear on the right
s_{RR}=half the tread of the right rear wheel
δ=steering lock angle of the steered wheels

In order to improve the dynamics of the steering angle correction method the compensation gain K_{FFW} and K_{FB} of the single fed back controlled quantities should be adjusted depending on the driving behavior of the vehicle and the environmental conditions.

The controlling portion Δδ_{z} of the steering angle demand Δδ is determined according to the relation Δδ_{z}=K_{FFW}(Δ\overline{p},v)*M_{z} on the basis of the determined acting interference yaw torque. In this case the average friction coefficient potential of the high-friction coefficient side and the low-friction coefficient side corresponds to the average brake pressure on the front axle if both front wheels are controlled by the ABS system thus fully exploiting the friction coefficient available in the single case. Here the compensation gain K_{FFW}(Δ\overline{p},v) taking into consideration the available average friction coefficient potential and the vehicle speed, determined by means of the rotation behavior of the wheels in the form of a vehicle reference speed is adapted by way of the average brake pressure of the front axle.

In another advantageous embodiment the second compensating portion Δδ_{R} of the steering angle demand Δδ is determined by a P portion Δδ_{R,P} based on the yaw rate deviation Δ\dot{ψ} and a D portion based on the yaw acceleration deviation Δ\ddot{ψ}. Here the P portion is determined on the basis of the relation Δδ_{P,R}=K_{FB,P}(v)*Δ\dot{ψ}. The gain factor K_{FB,P}(v) for the adaptation of the controlled quantity yaw rate deviation Δ\dot{ψ} depends on the vehicle speed which is determined by the rotation behavior of the wheels in the form of a vehicle reference speed.

The D portion is determined in an advantageous manner according to the relation δ_{R,D}=K_{FB,D}(v)*Δ\ddot{ψ}, where the gain factor for the feedback of the controlled quantity yaw acceleration deviation Δ\ddot{ψ} depends on the vehicle speed.

The method for increasing the driving stability of a motor vehicle includes at least one ABS control function in order to be able to develop an ABS control method in which a driving condition caused by braking operations with different brake pressures or brake forces on the single wheels and defined by the determined brake force difference, in such a favorable way that the instabilities caused by the driving condition can at least in part be compensated by an intervention in an open-loop or closed-loop controlled steering system. In this case it is an advantage that the ABS control function is a part of an ESP control.

The correction of the steering angle is admitted if a driving condition with different friction coefficients on each side (μ-Split) has been recognized. The recognition of a driving condition or a course where the deviation between the vehicle movement and the driver's input is caused by different brake pressures or forces is determined and steering interventions are admitted if at least the following conditions are satisfied:
If it is recognized that the vehicle is driving straight ahead:
a) stop light switch signal present and
b) stop light switch sensor in working order and
c) brake actuation by the driver has been recognized by means of TMC pressure and
d) driving forward has been recognized and
e) one of the following conditions is also satisfied
   e1) if one front wheel is controlled by the ABS system for a certain period of time and the other front wheel is not controlled by the ABS system or
   e2) if both front wheels are in the first ABS cycle and the pressure difference on the front axle exceeds a limit value or
   e3) if both front wheels are controlled by the ABS system for a certain period of time and at least one front wheel shows a certain minimum ABS blocking pressure and one blocking pressure exceeds the blocking pressure of the other wheel by more than a certain limit value.
If it is recognized that the vehicle is cornering:
a) Stop switch signal present and
b) stop switch sensor in working order and
c) brake actuation by the driver has been recognized by means of TMC pressure and
d) driving straight ahead has been recognized and
e) one of the following conditions is also satisfied
   e1) the curve outer front wheel is controlled by the ABS system before the curve inner front wheel or if for a certain period of time
   e2) both front wheels are being controlled by the ABS system and at least one front wheel shows a certain minimum ABS blocking pressure and the blocking pressure of the curve inner wheel exceeds the blocking pressure of the curve outer wheel by more than a certain limit value.

For deactivating the steering angle correction method, at least one of the following requirements must be satisfied so that the active steering interventions are finished:

a) no front wheel is being controlled by the ABS system or

b) there is no stop switch signal or

c) the stop switch sensor is defective or

d) the brake actuation by the driver is not recognized (no TMC pressure present).

In μ-Split driving conditions the ABS brake pressure control can preferably be modified by means of the ABS control method. According to the present invention an ABS brake pressure control with single wheel control is to be provided at least on one vehicle axle in which the deviation between the vehicle movement and the driver's control input occurring with the ABS control due to the different friction coefficient on the two vehicle sides is compensated at least in part by that a compensation steering angle is determined and is superimposed on the vehicle steering angle. The ABS brake pressure control is characterized by the following steps:

admission of high pressure build-up gradients on the wheel with a high friction coefficient.

admission of pressure differences on the rear axle according to the relation Δp_{HA}=f(\dot{ψ},δ_{Whl},v,a_{y}).

In order to maintain the ABS control function in each and every situation thus maintaining the maneuverability of the vehicle during braking with high brake pressure, it is intended that the conventional ABS control strategy is used in case of a breakdown of the controlled or regulated steering system.

One device includes a driving dynamics controller with at least one ABS function, preferably an ESP and ABS function, which is connected with an open-loop and/or a closed-loop control for correcting the steering, the device being built in such a way that it includes a first determination unit for determining the steering angle defined by the driver

a second determination unit for determining an interference compensation steering angle on the basis of brake forces and/or brake pressure or an interference yaw torque,

a third device for determining an interference compensation steering angle on the basis of the yaw behavior of the vehicle and

a logic unit for linking the first and the second interference compensation steering angle in order to obtain a compensation steering angle demand.

The following advantages result from the methods and devices:
The driver is relieved by automatic countersteering of the control system so that he, in the ideal case, does not have to correct anything.
The substantial advantage of the division into interference compensation and superimposed control of the driving condition is that by means of the interference parameter overlay it is possible to immediately react to the interference and not only when the vehicle tends to become instable. The superimposed control of the driving condition improves the total behavior of the vehicle, and interferences which cannot be compensated by the simple control (interference compensation) are hereby eliminated by control.
By recognizing the situation far more quickly than the driver and by countersteering far more quickly, the electronic brake system ABS can much better exploit the friction coefficient potential on the single wheels. For this reason the ABS strategies on inhomogeneous roads are adapted in such a way that on the front axle a much quicker pressure build-up on the wheel of the side with the high friction coefficient is admitted, and on the rear axle a pressure difference depending on the steering lock angle, the driving speed and the driving condition parameters (e.g. yaw rate or lateral acceleration) is admitted (softened SelectLow). By better exploiting the friction coefficient potentials, particularly on the side with a high friction coefficient, the stop distances are much shorter.
By using the control system in combination with an active steering system and by means of the adapted ABS control strategies, the conflict between the countersteering expenditure and the brake distance prolongation occurring during brake operations on inhomogeneous friction coefficients can be solved to a high degree. For the driver, there are significant advantages in terms of safety (shorter stop distance and vehicle stability) as well as in terms of comfort (considerably less expenditure for the driver to countersteer).

One embodiment of the present invention is described more in detail in the following figures.

### BRIEF DESCRIPTION OF THE DRAWINGS

In the figures,

FIG. 1 shows a schematic representation of the asymmetric brake forces of a vehicle and the resulting interference yaw torque of a μ-Split road,

FIG. 2a shows the pressure development on the front axle in case of active yaw torque limitation according to the state of the art,

FIG. 2b shows the pressure development on the rear axle with active SelectLow according to the state of the art,

FIG. 3 shows a block diagram representing the control system with interference parameter overlay and superimposed control of the driving condition,

FIG. 4 shows a block diagram representing the interference parameter overlay with an estimation of the interference yaw torque,

FIG. 5 shows a block diagram representing the superimposed control of the driving condition,

FIG. 6 shows a block diagram representing the determination of the pressure difference on the rear axle on the basis of the driving dynamics condition of the vehicle,

FIG. 7a shows the pressure development on the front axle with adapted yaw torque limitation according to the present invention,

FIG. 7b shows the pressure development on the rear axle due to a modification of the SelectLow according to the present invention,

FIG. 8 shows a representation of the vehicle geometry, and

FIG. 9 shows a representation of the ABS control cycle.

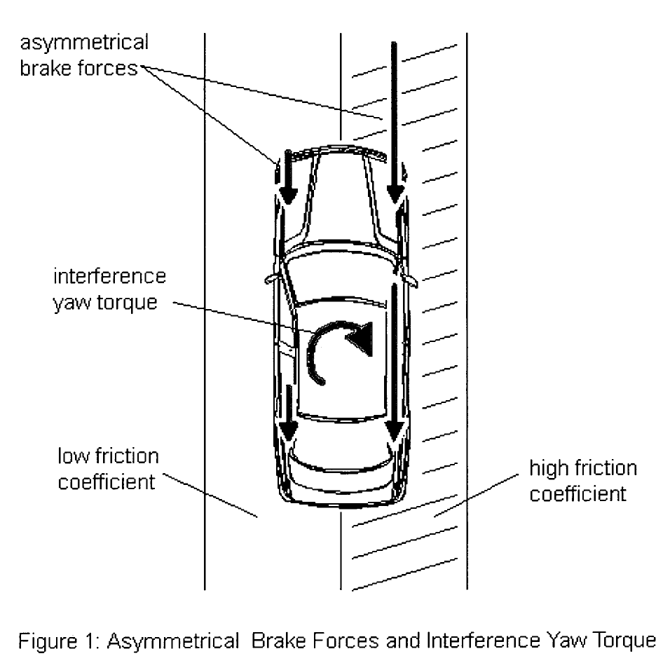

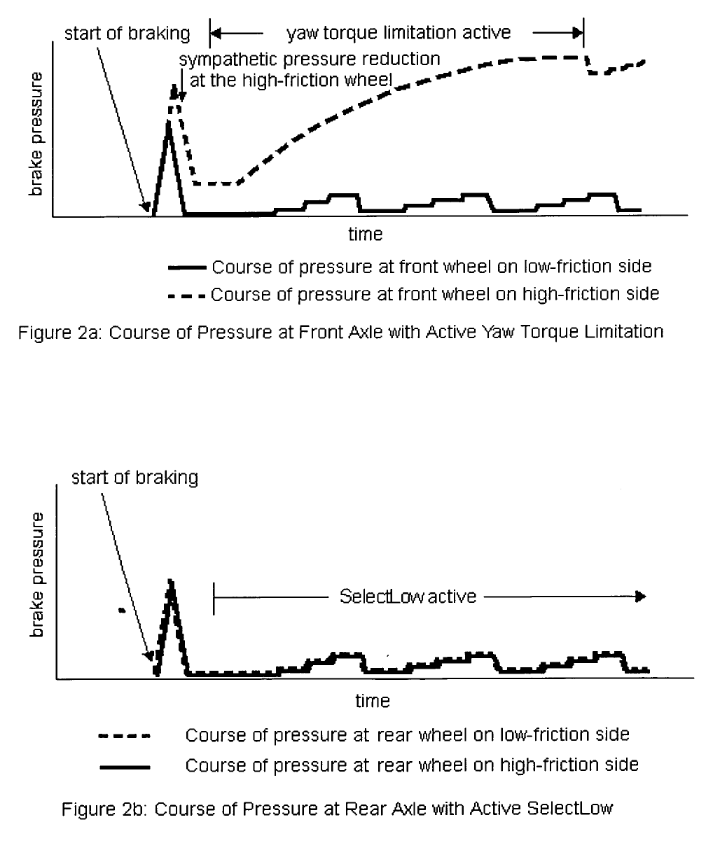

### DETAILED DESCRIPTION OF THE DRAWINGS

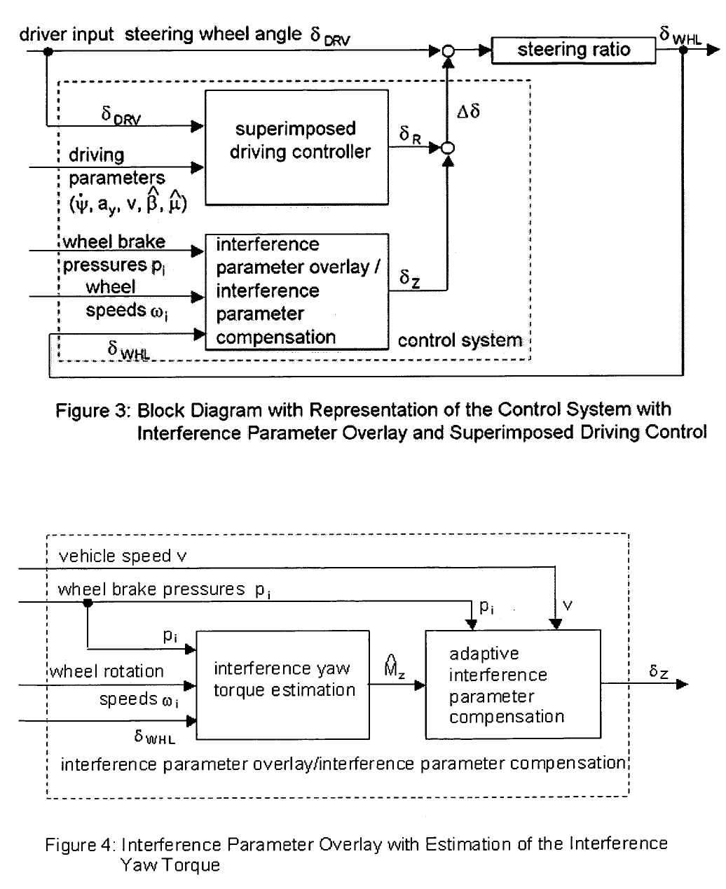

The steering lock angle necessary for the automatic countersteering is determined by a calculating unit 30 (FIG. 3) which composes the steering lock angle on the basis of two portions (interference parameter overlay and superimposed driving control).

The first portion results from the interference parameter overlay or interference parameter compensation of the interference yaw torque \hat{M}_{z} caused by the asymmetric brake forces during braking. This interference yaw torque is first estimated in a determination unit 40, schematically represented in FIG. 4, based on the brake pressure information of the single wheels, according to the equations 1 and 2. The input parameters introduced into the determination unit are the wheel brake pressures pᵢ, the wheel rotation speed ωᵢ, and the wheel locking angle feedback δ_{WHL}. An electronic brake system is necessary for determining the wheel brake pressures, which either estimates or observes the brake pressures on the single wheels on the basis of the model and measures the brake pressures of the single wheels by means of pressure sensors, or a brake-by-wire system (EHB/EMB) which bases on these parameters. The determination of the interference yaw torque according to equation 2 bases on brake forces \hat{F}_{x,i} on the wheels. The brake forces can—as indicated in equation 1—be calculated essentially on the basis of the brake pressure information. Alternatively, systems can be used which directly measure the brake forces (e.g. side panel torsion sensor, hubs and similar). The steering lock angle δ_{Z} which depends on the driving parameters (e.g. vehicle speed, brake pressure difference between high and low friction coefficient, average brake pressure level etc.) and is necessary for compensating the interference yaw torque (FIG. 4) is calculated in an adaptive manner from the estimated interference yaw torque. With regard to the lateral dynamics, the interference parameter overlay functions as a mere control. This results in that the interference yaw torque is not compensated ideally in all cases since it is superimposed by other interferences and inaccuracies which are not captured. Inaccuracies may occur, for example, due to changes of the brake disk friction coefficient.

Thus the interference parameter overlay—as represented in FIG. 3—is superimposed by a driving controller 50. This driving controller which is represented in FIG. 5 and will be described more in detail later on, defines an additional steering lock angle δ_{R} on the basis of the driving parameters, such as yaw rate and optionally in addition also the lateral acceleration or the floating angle of the vehicle. Device 50, i.e. the controller, works in an adaptive manner, i.e. the control gain of the single fed back driving conditions is adapted e.g. on the basis of the vehicle speed v.

These two steering angle actuating demands (resulting from the interference parameter overlay and the superimposed driving control) are preferably summed up in a adding unit 31 and adjusted by the active steering system in the form of a steering lock angle δ_{WHL}. The determination of the steering lock angle δ_{WHL} necessary for the stabilization and the adjustment of the steering lock angle occur much quicker than an average driver can recognize the situation and react by countersteering. This quick reaction of the control system and the active steering system allows the electronic brake system ABS to be adapted in such a way that the friction coefficient potential on the single wheels (in particular on the high friction coefficient side) can be exploited much better).

To this end the control strategies of the ABS system on inhomogeneous friction coefficients are modified:

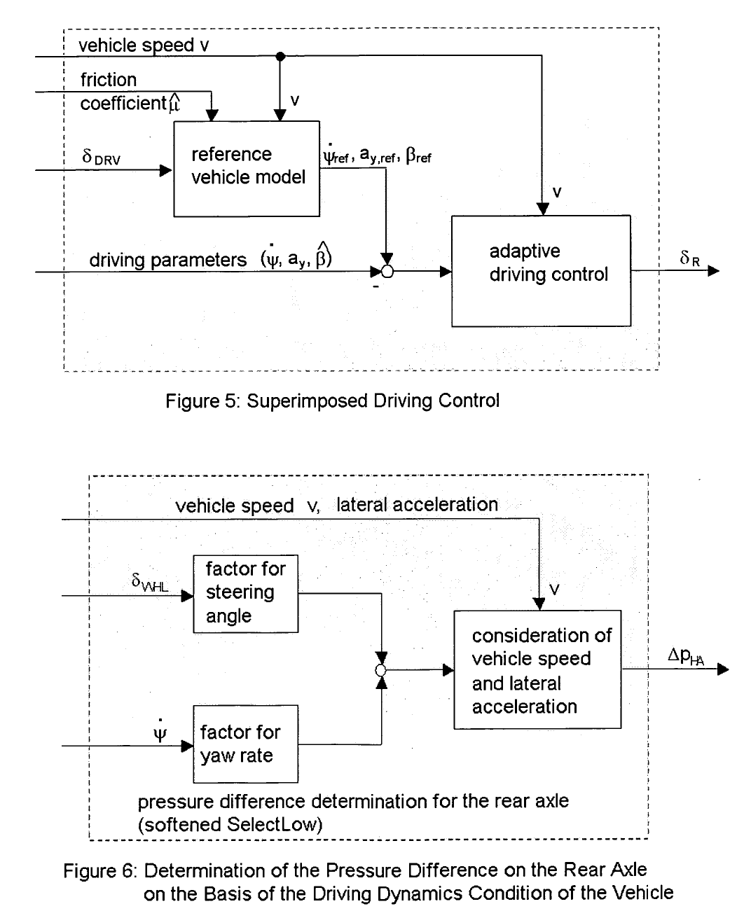

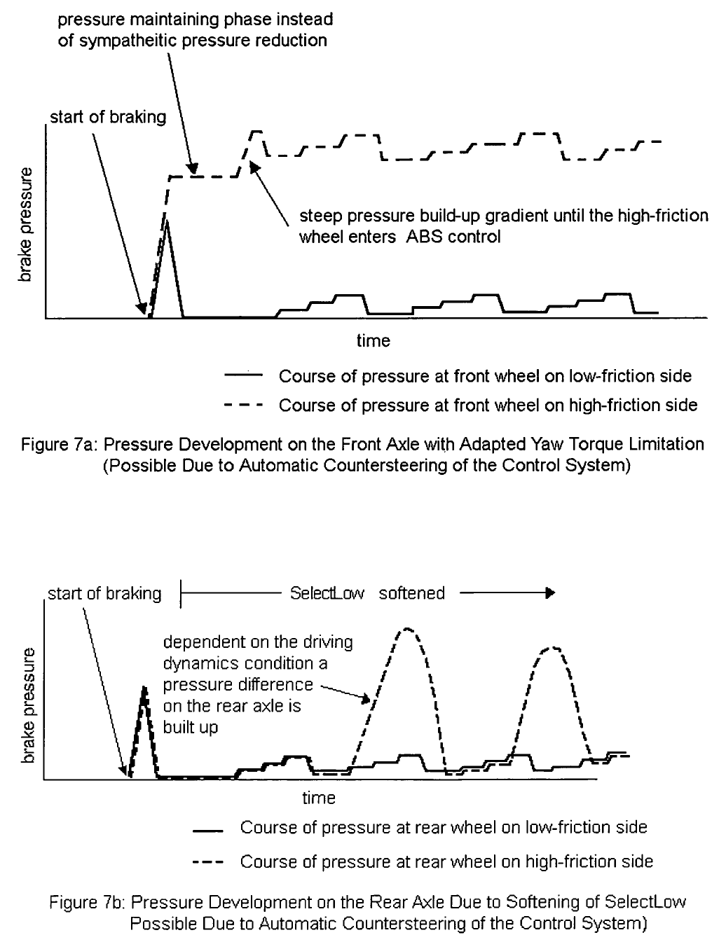

The yaw torque limitation on the front axle is considerably reduced so that a big pressure difference quickly builds up between the wheel on the high friction coefficient side and the one on the side with a low friction coefficient (high pressure build-up gradient on the wheel with a high friction coefficient). Nearly contemporarily to the build-up of the pressure difference, a yaw torque around the vertical vehicle axis is generated. Due to the estimated interference yaw torque resulting from the brake pressure information according to the equations 1 and 2 or by means of a system measuring directly the wheel forces, the controller immediately countersteers, even before the driver can recognize the situation on the basis of the yaw behavior of the vehicle. A second measure to obtain a better brake performance is to modify also SelectLow in such a way that a pressure difference is admitted also on the rear axle. However, this pressure difference is not always admitted, but depends on the steering angle, which is restricted by the vehicle speed and the driving parameters (equation 3, FIG. 6). If the steering lock angle points toward the side with the low friction coefficient and if the vehicle turns towards the side with the low friction coefficient, a pressure difference is admitted on the rear axle. This leads to a higher brake force on the side with the high friction coefficient, the interference yaw torque increases and at the same time the lateral force potential on this wheel is reduced. Due to the bigger interference yaw torque, the rotation to the side with the low friction coefficient stops and the vehicle begins to turn towards the side with the high friction coefficient. By turning towards the side with the high friction coefficient the admitted pressure difference on the rear axle and thus the brake force on the side with the high friction coefficient are reduced at the same time, which again leads to more side force potential on the rear wheel on the side with the high friction coefficient. By this and by the superimposed steering interventions of the control system interacting with the active steering system, the vehicle is stabilized. Nevertheless the driver can steer towards the side with the high or the low friction coefficient, according to his steering input. The pressure difference on the rear axle admitted by the driving dynamics weakening of the SelectLow is limited to a maximum pressure difference so that the rear wheel on the side with the high friction coefficient does not lose too much side force potential. In case of high speed or increasing lateral acceleration this maximum admitted pressure difference on the rear axle can be reduced to zero (corresponds to SelectLow).

These modifications in the ABS control strategy (high pressure build-up gradient for the yaw torque limitation on the front axle as well as softened SelectLow on the rear axle according to the driving condition) lead to an essentially better utilization of the available friction coefficient potential. Hereby the brake distance can be reduced significantly.

When the active steering system fails, the conventional ABS control strategy (yaw torque limitation and SelectLow) is utilized.

The steering angle correction system works as follows:

The method of correcting the compensating steering angle is activated on the basis of a recognized μ-split situation. According to an advantageous embodiment, the recognition of a μ-split driving condition is based on the following sensor signals:
stop light switch signal (SLS)
pressure sensor signal of the tandem main cylinder (TMC)
pressure sensor signals of the wheel brake circuit
wheel rotation sensors
yaw rate sensor(s)
lateral acceleration sensor(s)
internal ESP condition (ESP signals regarding ESP interventions)

The distinction between driving straight ahead and cornering (right or left-hand curve) is made by means of the yaw rate and the lateral acceleration. Depending on whether the vehicle is driving straight ahead or is cornering, the following signals must be present in order to activate the correction of the compensating steering angle:

The μ-split driving condition is recognized as follows when driving straight ahead:
stop light switch signal (SLS) is present, stop light switch sensor is in working order, braking actuation by the driver is recognized by means of the TMC pressure, driving forward is recognized and at least one front wheel is controlled by the ABS system, or
if after exceeding one first time-dependent limit value one front wheel is controlled by the ABS system and the other front wheel is not controlled by the ABS system
or if both front wheels are in the first ABS cycle and the pressure difference on the front axle exceeds a first pressure-dependent limit value, or
if after exceeding a second time-dependent limit value both front wheels are controlled by the ABS system and at least one front wheel shows an ABS blocking pressure which exceeding a second pressure-dependent limit value and the ABS blocking pressure on a front wheel corresponds to at least x times the blocking pressure of the other front wheel.

A μ-split driving condition which has been recognized when driving straight ahead is reset as follows:

The ABS system does not control any front wheel or there is no SLS or the SLS sensor is defective or the brake actuation by the driver is not recognized or

there is an SLS and the SLSS sensor is in working order and the brake actuation by the driver is recognized and after exceeding a time-dependent limit value the ABS blocking pressure on both front wheels is smaller than a pressure-dependent limit value or the ABS blocking pressure on one front wheel does no longer correspond to at least x times the blocking pressure of the other front wheel.

During cornering the μ-split driving condition is recognized as follows:
the stop light switch signal (SLS) is present, stop light switch sensor is in working order, brake actuation by the driver is recognized by means of the TMC pressure, driving forward is recognized and at least one front wheel is controlled by the ABS system and
the curve outer front wheel is controlled by the ABS system before the curve inner front wheel, or
if both front wheels are controlled by the ABS system for more than a preset period of time and at least one front wheel shows an ABS blocking pressure exceeding a limit value and the ABS blocking pressure on a curve inner front wheel corresponds to at least x times the blocking pressure of the curve outer front wheel.

A μ-split driving condition which has already been recognized during cornering is reset as follows:
The ABS system does not control any front wheel or there is no SLS or the SLS sensor is defective or the brake actuation by the driver is not recognized, or
there is an SLS and the SLS sensor is in working order and the brake actuation by the driver is recognized and the ABS blocking pressure on both front wheels is smaller than a limit brake value for more than the preset period of time or the ABS blocking pressure on the curve inner front wheel does no longer correspond to at least x times the blocking pressure of the curve outer front wheel.
   Compensating Steering Requirement

In order to activate the compensating steering demand, the μ-split driving condition must have been recognized and the compensating steering demand must have been activated as described above. The steering angle demand Δδ is based on two portions: the first portion Δδ_{Z} is defined by means of the interference parameter compensation (control portion) compensating the acting interference yaw torque. This control portion is superimposed by a control portion Δδ_{R} based on the yaw behavior of the vehicle. The two portions described in the following (control and control portion) are summed up resulting in the total steering demand Δδ to
Δδ=Δδ_{Z}+Δδ_{R}.

The steering demand is based on the following sensor signals:
pressure sensor signals in each wheel brake circuit
yaw rate signals
nominal steering angle signals “driver's steering angle demand”
total steering angle signals on the wheel
wheel rotation speed sensor signals
lateral acceleration signals
SLS signals
pressure sensor signals of the TMC
ESP condition (ESP interventions)
ESP condition (reset of the single-track model)
   Open-Loop Control Portion (Interference Parameter Compensation)

The control portion of the steering demand corresponds to an interference parameter compensation. In this case the interference yaw torque M_{z} acting as interference parameter and resulting from the asymmetrical brake forces, is compensated to a high degree by direct feedback from the compensation gain K_{FFW}(\overline{p}_{FA},v). The estimated interference yaw torque is the direct input parameter for the additional steering angle demand Δδ_{Z} of the control portion (FFW=Feed Forward Control). The following relation applies
Δδ_{Z}=K_{FFW}(\overline{p}_{FA},v)·M_{z}·

The interference yaw torque is estimated by means of the cinematic rigid body relations on the basis of the brake forces of the single wheels and the steering angle lock of the front wheels. The static brake forces of the single wheels are defined on the basis of the ABS blocking pressures of the single wheels and the dimensions of the wheel brake. Additionally, the wheel accelerations must be considered in order to calculate the dynamic brake forces. The definition of the ABS blocking pressures is described later on.

The compensation gain factor K_{FFW}(\overline{p}_{FA},v) is adapted by way of the average brake pressure on the front axle. If both front wheels are controlled by the ABS system, the average brake force on the front axle corresponds to the total (average of left and right vehicle side) available friction coefficient potential. This friction coefficient potential again influences the compensating steering angle which can be set with the active steering.

In case of small driving speeds (between 10 and 2 km/h), the additional steering angle demand Δδ_{Z} is faded off in a linear manner up to Δδ_{Z}=0.

Summary Control Portion:

The steering portion based on the interference parameter compensation depends basically on the steering angle lock of the front wheels and the ABS blocking pressures which are based—as is described later on—essentially on the pressure sensor signals and the ABS phase information (defined from the wheel rotation speed sensor signals).

Closed-Loop Control Portion

The control portion Δδ_{R} of the steering demand based on the yaw behavior of the vehicle, consists of a P portion Δδ_{R,P} (controlled quantity yaw rate deviation) and a D portion Δδ_{R,D} (controlled quantity yaw acceleration deviation). The P and D portions described in the following are added resulting in the total control portion Δδ_{R} as follows:
Δδ_{R}=Δδ_{R,P}+Δδ_{R,D}.
P Portion (Yaw Rate Deviation)

The controlled quantity for the P portion corresponds to the yaw rate deviation Δ\dot{ψ}. For the steering demand portion resulting from the P portion, the following control law applies
Δδ_{R,P}=K_{FB,P}(v)·Δ\dot{ψ}.

The yaw rate deviation Δ\dot{ψ} is defined as difference between the measured yaw rate of the vehicle \dot{ψ}ᵢₛₜ and the reference yaw rate of the vehicle \dot{ψ}_{ref} (single-track model) defined on the basis of the driver's direction input (driver's steering angle including variable steering ratio) thus resulting in
Δ\dot{ψ}=\dot{ψ}ᵢₛₜ−\dot{ψ}_{ref}.

The actual yaw rate of the vehicle \dot{ψ}ᵢₛₜ is measured directly with a yaw rate sensor. The yaw rate sensor is combined with a lateral acceleration sensor in a sensor cluster in which the yaw rate as well as the lateral acceleration with redundant sensor elements are measured.

The reference yaw rate of the vehicle \dot{ψ}_{ref} is defined by means of a single-track model of the vehicle. The most important input parameters for the one-track model are the manual driver input (driver's steering angle including variable steering ratio portions) and the vehicle speed. The actual friction coefficient of the road surface is defined by means of the measured lateral acceleration and the resulting friction coefficient potential is considered in the one-track model when calculating the reference yaw rate.

The gain factor K_{FB,P}(v) for the controller feedback of the yaw rate deviation Δ\dot{ψ} is adapted by way of the actual vehicle speed v. Since the vehicle speed influences the driving behavior of the vehicle in a significant manner, this is considered in the controller gain and thus also in the circuit closed by way of the controller of the vehicle.

D Portion (Yaw Acceleration Deviation)

The controlled quantity for the D portion corresponds to the yaw acceleration deviation Δ\ddot{ψ}. For the steering demand portion resulting from the D portion, the following applies
Δδ_{R,D}=K_{FB,D}(v)·Δ\ddot{+104}.

The yaw acceleration deviation Δ\ddot{ψ} is determined by differentiating the yaw rate deviation Δ\ddot{ψ}.

$$Δ \ddot{ψ} = \frac{ⅆ}{ⅆ t} Δ \dot{ψ} = \frac{ⅆ}{ⅆ t} ( {\dot{ψ}}_{ist} - {\dot{ψ}}_{ref} ) .$$

The yaw acceleration deviation is thus based on the same signal sources as the yaw rate deviation: measured yaw rate of the vehicle \dot{ψ}ᵢₛₜ and reference yaw rate of the vehicle \dot{ψ}_{ref} which depends immediately from the driver's direction input (driver's steering angle including variable steering ratio portions) and the vehicle speed. (Consideration of the actual friction value of the road by means of the measured lateral acceleration).

The gain factor K_{FB,D}(v) for the controller feedback of the yaw acceleration deviation Δ\ddot{ψ} is adapted by way of the actual vehicle speed. Since the vehicle speed influences the driving behavior of the vehicle in a significant manner, this is considered in the controller gain and thus also in the control circuit of the vehicle closed by the controller.

Summary Control Portion

The control portion Δδ_{R} is based essentially on the signal of the yaw rate sensor \dot{ψ}, the driver's steering angle demand δ_{DRV} including variable steering ratio and the vehicle speed v which is based on the signals of the wheel rotation speed sensors.

Calculation of the ABS Blocking Pressure

The brake pressure on the wheel is defined as ABS blocking pressure which causes the wheel tending to block. If the friction coefficient during an ABS braking operation is nearly homogenous, the brake pressure on the wheel oscillates around the ABS blocking pressure. The ABS blocking pressure is determined individually for each wheel in the following manner:

If the wheel is not in the first ABS control cycle and the ABS system determines that the wheel is instable thus tending to block (ABS phase 2) and if the wheel in the preceding control loop was not yet in phase 2 or phase 4, then at least 85%, preferably 95%, of the actual wheel pressure are frozen as ABS blocking pressure of the wheel. If the wheel is neither controlled by the ABS system nor in the first ABS control cycle, the wheel pressure is used instead of the ABS blocking pressure. If the wheel is controlled by the ABS system, but is not in phase 2, the maximum of the last ABS blocking pressure and 95% of the wheel pressure is used since in pressure build-up phases the wheel pressure may exceed the last ABS blocking pressure. If a wheel is instable for more than a period of time between 90 and 110 ms (phase 2) the ABS blocking pressure is no longer used, but the wheel pressure, since the wheel pressure has deviated too much from the ABS blocking pressure due to the continual pressure reduction.

If the wheel pressure amounts to less than 50% of the last ABS blocking pressure or if the brake slip of the wheel corresponds to more than 50%, the wheel pressure is taken again (recognition of a friction coefficient transition from high friction coefficients to low friction coefficients).

If the ESP system intervenes on a wheel, the ABS blocking pressure is not adapted, but maintained constant.

If the driver does not brake anymore, the ABS blocking pressures are reset to zero.

Summary:

The determination of the blocking pressure is based essentially on the pressure sensor signals and the necessary ABS phase information is based essentially on the wheel rotation speed sensors.

ABS Phase Information and ABS Control Cycle:

| ABS phase | Wheel condition | ABS action |
|---|---|---|
| Phase 0 | no ABS control | unpulsed pressure build-up |
| Phase 1 | no ABS control, | pulsed pressure build-up |
| from 0 | insignificant wheel | |
| | dynamics | |
| Phase 2 | instable wheel, high | pressure reduction |
| | amount of slip at the | |
| | wheel | |
| Phase 4 | instable wheel, wheel | maintain pressure, |
| | leaves the slip range | pulsed pressure build-up |
| Phase 3 | stable wheel, low slip on | pulsed pressure build-up |
| | the wheel | |
| Phase 1 | wheel shows insignificant | maintain pressure |
| from 3 | dynamics | |
| Phase 5 | wheel is spinning | unpulsed pressure build-up |
| from 0 | | |
| Phase 5 | wheel is spinning | unpulsed pressure build-up |
| from 3 | | |

Equations:

1. Estimation of the brake forces on the basis of the brake pressures:
Equation showing the factors influencing a wheel neglecting driving torque and assuming that the wheel contact force applies in the wheel contact point
   J_{Whl}\dot{ω}ᵢ=M_{br,i}+F_{x,i}r_{Whl}.
This results together with a brake torque of M_{br,i}=B*pᵢ for the estimation of the circumferential force \hat{F}_{x,i} from brake pressure and wheel acceleration in

$${\hat{F}}_{x , i} = \frac{1}{r} {B}^{*} {p}_{i} + \frac{1}{r} {J}_{Whl} {\dot{ω}}_{i} .$$
In case of lower accuracy requirements the dynamic portion

$$\frac{1}{r} {J}_{Whl} {\dot{ω}}_{i}$$
may be neglected. Stationarily the brake force results in

$${\hat{F}}_{x , i} = \frac{1}{r} {B}^{*} {p}_{i}$$

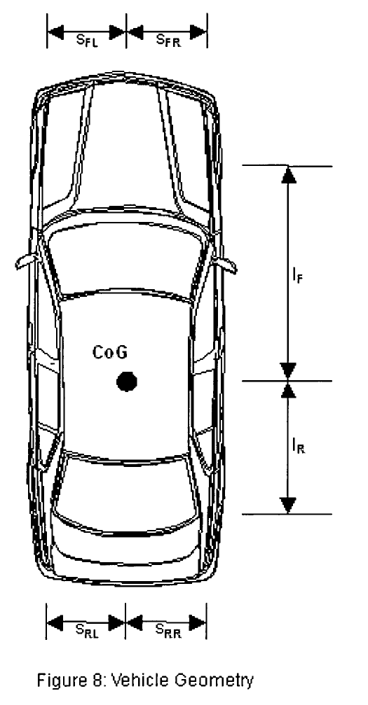

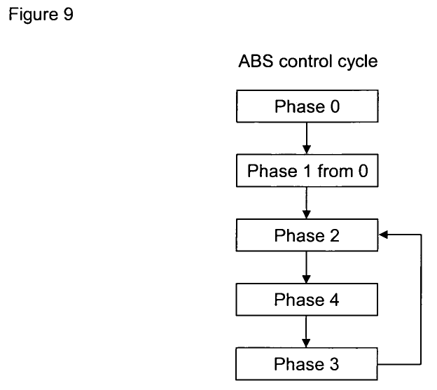

2. Estimation of the interference yaw torque from the brake forces
For vehicles with front wheel steering with the steering angle lock δ and the vehicle geometry according to FIG. 8 the interference yaw torque results in
   \hat{M}_{z}=cos(δ)└\hat{F}_{FL}s_{FL}−\hat{F}_{FR}s_{FR}┘−sin(δ)└\hat{F}_{FL}l_{F}+\hat{F}_{FR}l_{F}┘+\hat{F}_{RL}s_{RL}−\hat{F}_{RR}s_{RR}.

3. SelectLow:
On the rear axle a pressure difference is admitted which depends on the driving dynamics condition. For the admitted pressure difference on the rear axle applies
   Δp_{HA}=f(\dot{ψ},δ_{Whl},v,a_{y}).

1-23. (canceled)

24. A method for increasing the driving stability of a motor vehicle during braking, in which compensation steering angles for a controllable steering system are calculated from several input parameters, so that the driving stability of the motor vehicle is increased by steering interventions,
wherein in the steering interventions an interference compensation portion is considered in the calculation of the compensation steering angles on the basis of the driving condition of the vehicle.

25. The method according to claim 24, comprising the steps of
determining a first interference compensation portion of the compensating steering angle demand Δδ taking into consideration brake force differences on braked wheels of the vehicle, and
determining a second interference compensation portion from the driving condition of the motor vehicle and modification of the steering angle depending on interference compensation portions.

26. The method according to claim 25,
wherein the second compensation portion is calculated in a device including a reference vehicle model circuit in which the input parameters necessary for defining the course, such as vehicle speed, steering angle, and—if necessary—friction coefficient, are introduced, which due to a vehicle model being built in the reference vehicle model circuit and simulating the characteristics of a vehicle defines a nominal value for a controlled quantity and in which this nominal value is compared with a measured value for this controlled quantity in a comparative unit, calculating the second compensation portion of the steering angle Δδ_{R} on the basis of the comparative value representing the controlled quantity.

27. The method according to claim 26,
wherein one element out of the group consisting of yaw angle speed, lateral acceleration, and floating angle, is defined as nominal value for the controlled quantity.

28. The method according to claim 25,
wherein the first compensation portion Δδ_{Z} is determined taking into consideration an interference yaw torque M_{z} calculated from different brake forces and the second portion Δδ_{R} is determined taking into consideration vehicle yaw behavior.

29. The method according to claim 25,
wherein the first compensation portion is an open-loop control portion and the second compensation portion is a closed-loop control portion.

30. The method according to claim 24,
wherein the interference yaw torque M_{z} is calculated from a logical operation of a steering lock angle of steered wheels, of brake forces and of rotational behavior of the wheels.

31. The method according to claim 30,
wherein the brake forces are calculated from brake pressures on the basis of the relation
\hat{F}_{x,i}=f{r,B,pᵢ,J_{Whl},\dot{ω}ᵢ}
with
\hat{F}_{x,i}=Brake force on one wheel i
r=dynamic wheel radius
B=Brake parameter
pᵢ=Wheel brake pressure
J_{Whl}=Moment of inertia of the wheel
\dot{ω}ᵢ=Rotation acceleration of a wheel i
or
\hat{F}_{x,i}=f{r,B,pᵢ}.

32. The method according to claim 31,
wherein the interference yaw torque is calculated on the basis of the relation
\hat{M}_{z}=f{\hat{F}_{FL},s_{FL},\hat{F}_{FR},s_{FR},l_{F},\hat{F}_{RL},s_{RL},\hat{F}_{RR},s_{RR},δ}
with
\hat{F}_{FL}=Brake force on the front at the left
s_{FL}=half the tread of the left front wheel
\hat{F}_{FR}=Brake force on the front at the right
s_{FR}=half the tread of the right front wheel
l_{F}=Distance between front axle and center of gravity
\hat{F}_{RL}=Brake force on the rear at the left
s_{RL}=half the tread of the left rear wheel
\hat{F}_{RR}=Brake force on the rear at the right
s_{RR}=half the tread of the right rear wheel
δ=Wheel steering lock of the steered wheels

33. The method according to claim 24,
wherein compensation gains K_{FFW} of single feed-back controlled quantities are adapted depending on the driving behavior of the vehicle and possibly the environmental conditions.

34. The method according to claim 25,
wherein the second compensation portion Δδ_{R} of the steering angle compensation Δδ is calculated from a P portion Δδ_{R,P} based on a vehicle yaw rate deviation Δ\dot{ψ} and a D portion Δδ_{R,D} based on a yaw acceleration deviation Δ\ddot{ψ}.

35. The method according to claim 34,
wherein the P portion is calculated according to the relation
Δδ_{R,P}=K_{FB,P}(v)*Δ\dot{ψ}.

36. The method according to claim 35,
wherein the gain factor K_{FB,P}(v) for the feedback of the controlled quantity of the yaw rate deviation Δ\dot{ψ} depends on the vehicle speed.

37. The method according to claim 34,
wherein the D portion is calculated according to the relation
δ_{R,D}=K_{FB,D}(v)*Δ\ddot{ψ}.

38. The method according to claim 34,
wherein the gain factor K_{FB,D}(v) for the feedback of the controlled quantity yaw acceleration deviation Δ\ddot{ψ} depends on the vehicle speed v.

39. An ABS control method in which a yaw behavior resulting from brake actuations with different brake pressures or forces on the single wheels, which is defined from the determined brake force difference, is at least in part compensated by the intervention of a controlled steering system, wherein in the steering interventions an interference compensation portion is considered in the calculation of the compensation steering angles on the basis of the driving condition of the vehicle.

40. The ABS control method according to claim 39,
wherein a driving condition is determined by means of a yaw behavior resulting from different braking pressures or forces and admitting steering interventions, if at least the following conditions are satisfied with recognized straight-forward driving or cornering:
a) stop light switch signal present and
b) stop light switch sensor in working order and
c) brake actuation by the driver recognized by means of the TMC pressure and
d) driving straight forward is recognized.

41. The ABS control method according to claim 39,
wherein, after it is recognized that the vehicle is driving approximately straight forward, compensation steering angles are calculated if at least one of the following conditions is satisfied:
e1) if one front wheel is controlled by the ABS system for a certain period of time and the other front wheel is not controlled by the ABS system or
e2) if both front wheels are in a first ABS cycle and the pressure difference on the front axle exceeds a limit value or
e3) if both front wheels for a certain period of time are controlled by the ABS system and at least one front wheel shows a certain minimum ABS blocking pressure and one blocking pressure exceeds the blocking pressure of the other wheel by more than a limit value.

42. The ABS control method according to claim 39,
wherein, after it is recognized that the vehicle is cornering, compensation steering angles are calculated if at least one of the following conditions is satisfied:
e1) the curve outer front wheel is controlled by the ABS system before the curve inner wheel or
e2) if for a certain period of time both front wheels are controlled by the ABS system and at least one front wheel shows a certain minimum ABS blocking pressure and the blocking pressure of the curve inner wheel exceeds the blocking pressure of the curve outer wheel by more than a certain limit value.

43. The ABS control method according to claim 39,
wherein at least one of the following requirements must be satisfied in order to terminate the steering interventions:
a) no front wheel is controlled by the ABS system,
b) there are no stop light switch signals,
c) the stop light switch sensor is defective, or
d) the brake actuation by the driver is not.

44. An ABS brake pressure control method for a two-axle, four-wheel vehicle with single-wheel control on at least one vehicle axle in which due to a different friction coefficient on the two vehicle sides a yaw behavior occurring during ABS control is compensated at least in part by calculating a compensation steering angle for steering control and superimposing it on the vehicle steering angle, comprising the steps of
admitting high pressure build-up gradients on a wheel with a high friction coefficient
admitting pressure differences on the rear axle according to the relation
Δp_{HA}=f(\dot{ψ},δ_{Whl},v,a_{y}).

45. The ABS brake pressure control according to claim 44,
wherein a traditional ABS control strategy is used if the steering control fails.

46. A driving dynamic controller with at least an ESP and an ABS function being connected to a controller and/or a control for correcting the steering,
comprising a first determination unit for determining a steering angle required by the driver
a second determination unit for determining an interference compensation steering angle on the basis of brake forces
a third device for determining an interference compensation steering angle on the basis of the vehicle yaw behavior and
a logic unit for linking the first and the second interference compensation steering angle with a compensation steering angle demand.
